(19) United States
(12) Patent Application Publication
(10) Pub. No.: US 2017/0134894 A1
(43) Pub. Date: May 11, 2017

(54) SYSTEM AND METHOD OF LOCATING ELEVATOR SYSTEMS COMPATIBLE WITH A MOBILE HALL CALL AND CAR CALL SYSTEM

(71) Applicant: Otis Elevator Company, Farmington, CT (US)

(72) Inventor: Paul A. Simcik, Southington, CT (US)

(21) Appl. No.: 15/344,378

(22) Filed: Nov. 4, 2016

Related U.S. Application Data
(60) Provisional application No. 62/251,753, filed on Nov. 6, 2015.

(51) Int. Cl. H04W 4/02; B66B 1/46

(52) U.S. Cl. CPC H04W 4/02; B66B 1/468; B66B 2201/4653

(57) ABSTRACT

In one aspect, a system is provided including one or more elevator systems and a server for storing the system geographical location of the one or more elevator systems. A mobile device is in communication with the server. The mobile device is configured to display a one or more graphical objects indicative of the one or more elevator systems based in part on the system geographical location of the one or more elevator systems and a device geographical location of the mobile device.

### CROSS-REFERENCE TO RELATED APPLICATIONS

The present application is a nonprovisional patent application, which claims priority to U.S. Patent Application Ser. No. 62/251,753, filed on Nov. 6, 2015, which is herein incorporated in its entirety.

### TECHNICAL FIELD OF THE DISCLOSED EMBODIMENTS

The presently disclosed embodiments generally relate to elevator systems and more specifically, a system and method of finding available elevator systems within a predetermined range to limit a number of elevator systems displayed on a mobile device.

### BACKGROUND OF THE DISCLOSED EMBODIMENTS

Modern elevator systems are essential in multi-story buildings. Ideal use of an elevator system requires efficient and convenient means of requesting and dispatching elevator service. Generally, a passenger seeking elevator service must first initiate service via an elevator fixture located in the hallway immediately near an elevator (or a bank of elevators). Once the elevator car arrives the passenger boards and then selects a destination floor from a number of buttons on a car fixture.

Once the request for service is made, the passenger may have to wait up to several minutes for the car to arrive, and in certain situations, access to the car buttons may be obstructed. Current applications allow for registering access to elevators in multiple buildings. As the individual user registers access for many buildings, the list of available buildings to choose from becomes long. This may be cumbersome to select a desired building to request for elevator service.

### SUMMARY OF THE DISCLOSED EMBODIMENTS

In one aspect, a system is provided including one or more elevator systems and a server for storing the system geographical location of the one or more elevator systems. A mobile device is in communication with the server. The mobile device is configured to display a one or more graphical objects indicative of the one or more elevator systems based in part on the system geographical location of the one or more elevator systems and a device geographical location of the mobile device.

In a further aspect of the above, the mobile device is further configured to display the one or more graphical objects indicative of the one or more elevator systems based in part on a device geographical range.

In a further aspect of any of the above, the mobile device is further configured to transmit the device geographical location and the device geographical range to the server.

In a further aspect of any of the above, the server is configured to determine one or more matched elevator systems based in part on the device geographical location, the device geographical range, and the system geographical location. The server is also configured to transmit the one or matched elevator systems to the mobile device.

In one aspect, a method of locating one or more elevator systems is provided. The method includes determining a geographical location of a mobile device, and determining at least one elevator system within a geographical range of the geographical location of the mobile device. The method also includes displaying a one or more graphical objects on the mobile device, wherein the one or more graphical objects represent the at least one elevator system within the geographical range of the geographical location of the mobile device.

In a further aspect of the above, the method includes displaying a plurality of icons on the mobile device, each icon representing a different elevator system within the geographical range.

In a further aspect of any of the above, the method includes determining the geographical location of the mobile device with wireless communication.

In a further aspect of any of the above, the method includes determining the geographical location of the mobile device with a global positioning system.

In a further aspect of any of the above, the method includes communicating between the mobile device and the at least one elevator system with a transmitter and receiver.\

In a further aspect of any of the above, the method includes communicating between the mobile device and the at least one elevator system with wireless communication.

In a further aspect of any of the above, the method includes transmitting a travel signal from the mobile device to the at least one elevator system, and executing a hall call and car call for the at least one elevator system based on the travel signal.

### BRIEF DESCRIPTION OF DRAWINGS

FIG. 1 illustrates a schematic drawing of a system for controlling an elevator; and

FIG. 2 illustrates a schematic flow diagram of a method for initiating a hall and car call for an elevator system.

FIG. 3 illustrates a pair of mobile device displays.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

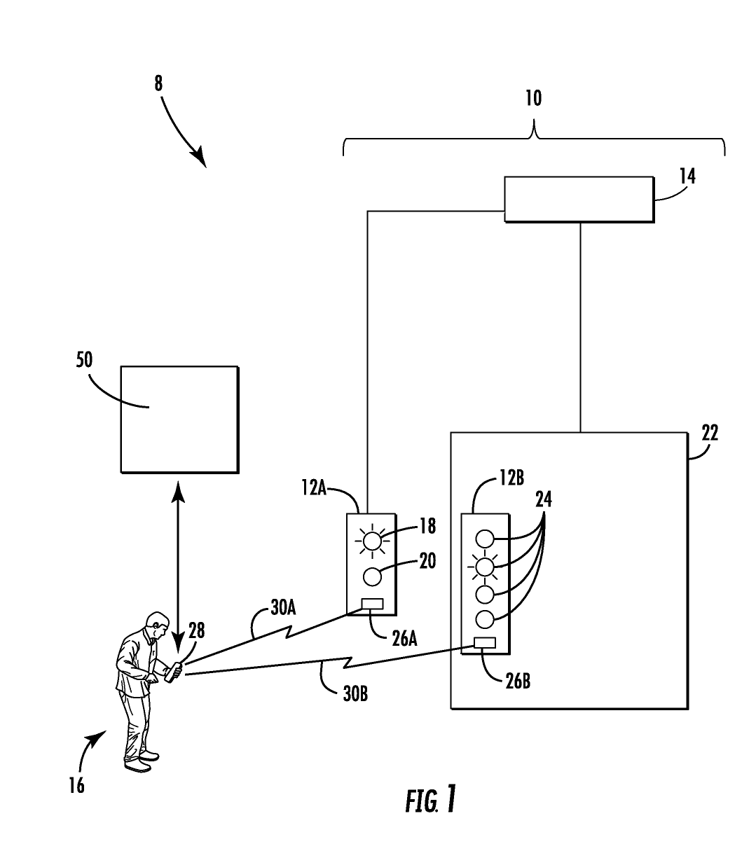

FIG. 1 illustrates selected portions of a system for operating an elevator, generally indicated at 8. In one embodiment, the system 8 includes an elevator system 10 having at least one elevator fixture 12 operably coupled to an elevator control system 14. In one embodiment, the at least one elevator fixture 12 includes a hall fixture 12A. In another embodiment, the at least one elevator fixture 12 includes a car fixture 12B. The elevator control system 14 may be configured to coordinate all aspects of elevator service such as travel, speed, and accelerating, decelerating, door opening speed and delay, leveling and hall fixture signals.

For example, when a passenger 16 typically wishes to initiate service for an elevator, the passenger 16 approaches the hall fixture 12A and presses the higher placed button 18 (i.e. up button) to request travel in the up direction, and presses the lower placed button 20 (i.e. down button) to request travel in the down direction.

The elevator control system 14 dispatches an elevator car 22 to the requested floor. Generally, after the arrival of the elevator car 22, the passenger 16 boards and then selects a button 24 from the car fixture 12B indicative of the passenger's destination floor. The elevator car 22 then travels to the requested destination floor, where upon arrival the passenger 16 exits the elevator car 22.

In the present embodiment, the passenger 16 may operate an application program stored on a mobile device 28 to view and select available elevator systems 10 for the purpose of remotely initiating hall and car calls based in part on the geographical location of the one or more elevator systems 10 and the mobile device 28. It will be appreciated that, in one embodiment, the mobile device 28 may be any mobile device operable to perform the functions disclosed herein, for example, a mobile telephone, tablet device, or any device capable of being carried by a person outside of a home, or other structure, to name a few non-limiting examples.

In one embodiment, the system 8 includes a server 50 constructed and arranged to store location data related to one or more elevator systems 10. For example, the server 50 may have the geographical location of one or more elevator systems 10 stored thereon. The mobile device communication device may be configured to wirelessly communicate with the server 50.

In an embodiment, the mobile device 28 may be configured to determine a geographical location of the mobile device 28. For example, the mobile device may be configured to determine a longitude and latitude of the mobile device 28. In one embodiment, the geographical location may be determined by a global positioning system. In one embodiment, the geographical location may be determined by wireless communications.

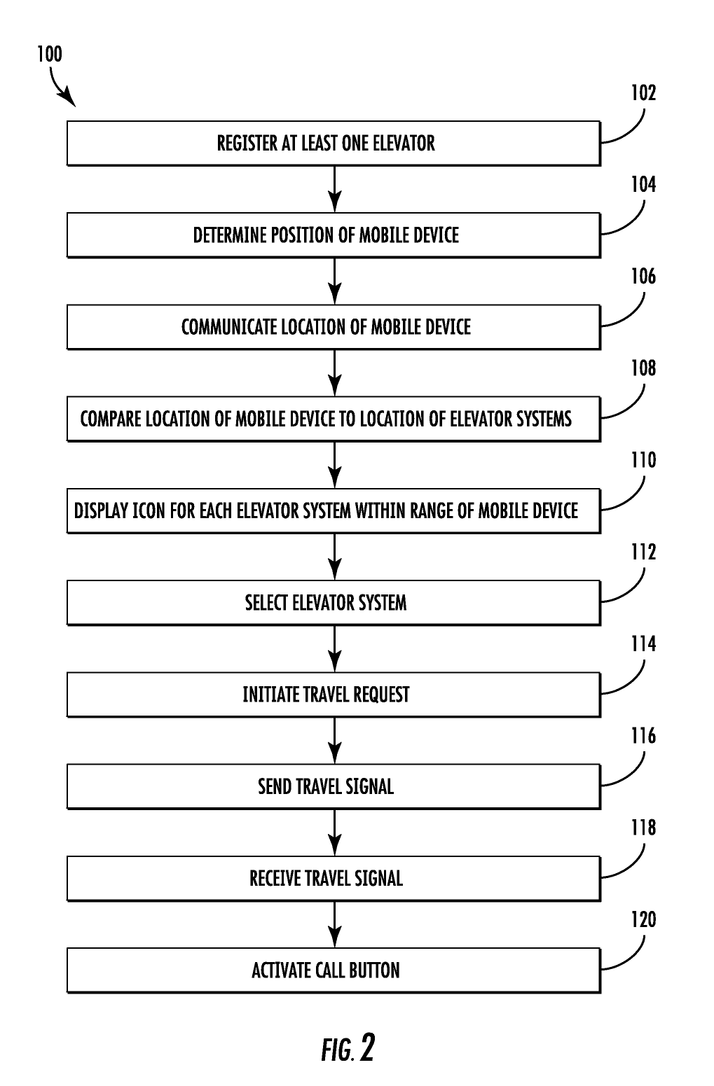

FIG. 2 illustrates a method, generally indicated at 100, of finding available elevator systems 10 within a predetermined device geographical range to limit a number of elevator systems displayed on the mobile device 28. The method 100 may include the step 102 of registering at least one elevator system 10 using a program on the mobile device 28. By registering at least one elevator system 10, the number of elevator systems 10 displayed on the mobile device 28 may be limited to only those elevator systems 10 used by the user. For example, the mobile device communication device may communicate with the server 50 to determine which buildings are supported by the system 8. A passenger 16 may then select various elevator systems 10 that the passenger 16 would like to control in the future using the mobile device 28. This selection process may take place remotely from the at least one elevator system 10. Alternatively, when the passenger 16 is in a building having an elevator system 10 that is capable of being controlled by a mobile device 28, the passenger 16 may add that elevator system 10 to the passenger's program at that time. Accordingly, in one embodiment, the mobile device 28 may have at least one input mechanism for calling an elevator system 10. For example, the input mechanism may be a button, a voice recognition device, or an icon representing an elevator system 10 and stored on the program of the mobile device 28. The icon may be visible on a display of the mobile device 28.

In an embodiment, the method 100 also includes the step 104 of determining a geographical location of the mobile device 28 using at least one of the mobile device positioning device, wireless technology, communication between device IP addresses, BLUETOOTH®, and/or the fusion of one or more data sets related to a position of the device. For example, a longitude and latitude of the mobile device may be determined. At step 106, the geographical location of the mobile device 28 is communicated to the server 50. At step 108, the server 50 may compare the geographical location of the mobile device 28 to the geographical location of the building containing the elevator system 10. In particular, the server 50 may determine which elevator systems 10 are within a pre-determined or user selected geographical range of the mobile device 28. In one embodiment, the range may be determined by a pre-determined or user selected radius with respect to the mobile device 28. In one embodiment, the server 50 may only identify those elevator systems 10 that have been registered by the passenger 16. In one embodiment, at step 110, the display of the mobile device 28 may display an graphical object indicative of each elevator system 10 identified by the server 50. Optionally, the graphical object of an elevator system 10 that was most recently used by the passenger 16 is displayed first.

The method 100 may include step 112 of selecting graphical object indicative of the elevator system 10, which the passenger 16 intends to initiate car and/or hall calls. At step 114 the mobile device 28 initiates a travel request by operating a program stored on the mobile device 28 to initiate a car call and a hall call. The method 100 further includes step 116 of operating the mobile device 28 to transmit a travel signal based on the travel request. In an embodiment, the travel signal includes a first travel signal 30A, wherein the first travel signal 30A is indicative of a direction of travel. In another embodiment, the travel signal includes a second travel signal 30B, wherein the second travel signal 30B is indicative of a destination floor.

The method 100 further includes step 118 of operating the at least one elevator fixture 12 to receive the travel signal 30. For example, fixture communication device 26A is operable to receive the first travel signal 30A, and fixture communication device 26B is operable to receive the second travel signal 30B. The method 100 further includes step 120 of operating the at least one elevator fixture 12 to activate a call button, 18, 20, or 24 based on the travel signal.

Upon arrival of the elevator car 22, the passenger 16 boards the elevator car 22 and the mobile device 28 transmits a second travel signal, indicating the desired floor, to the car fixture communication device 26B. Upon receipt of the second travel signal, the car fixture 12B activates and illuminates the car button 24 representing the desired floor as a confirmation that the passenger has requested travel to the desired floor. It will be appreciated that the passenger may request any floor serviced by the elevator system 10, in which case, the second travel signal would activate and illuminate the appropriate car button 24 representative of the requested floor. The elevator car 22 then travels to the requested destination floor, where upon arrival the passenger 16 exits the elevator car 22.

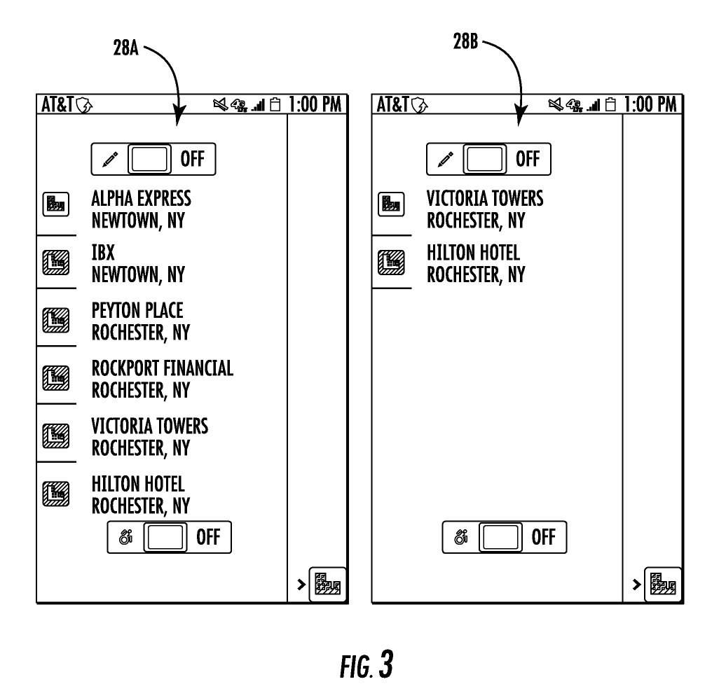

As illustrated in FIG. 3, mobile device 28A displays icons for every elevator system 10 registered on the mobile device 28A. Mobile device 28B displays icons for only those elevator systems 10 within a predetermined range of the mobile device 28B.

It will be appreciated that the elevator system 10 allows the passenger 16 to quickly, and seamlessly request elevator service within the passenger's proximity without having to scroll through various icons representing every elevator system 10 that the passenger utilizes.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. A system comprising:
one or more elevator systems;
a server for storing the system geographical location of the one or more elevator systems;
a mobile device in communication with the server, wherein the mobile device is configured to display a one or more graphical objects indicative of the one or more elevator systems based in part on the system geographical location of the one or more elevator systems and a device geographical location of the mobile device.

2. The system of claim 1, wherein the mobile device is further configured to display the one or more graphical objects indicative of the one or more elevator systems based in part on a device geographical range.

3. The system of claim 1, wherein the mobile device is further configured to transmit the device geographical location and the device geographical range to the server.

4. The system of any of claim 1, wherein the server is configured to:
determine one or more matched elevator systems based in part on the device geographical location, the device geographical range, and the system geographical location; and
transmit the one or matched elevator systems to the mobile device.

5. A method of locating one or more elevator systems, the method comprising:
determining a geographical location of a mobile device;
determining at least one elevator system within a geographical range of the geographical location of the mobile device; and
displaying a one or more graphical objects on the mobile device, wherein the one or more graphical objects represent the at least one elevator system within the geographical range of the geographical location of the mobile device.

6. The method of claim 5 further comprising displaying a plurality of icons on the mobile device, each icon representing a different elevator system within the geographical range.

7. The method of claim 5 further comprising determining the geographical location of the mobile device with wireless communication.

8. The method of claim 5 further comprising determining the geographical location of the mobile device with a global positioning system.

9. The method of claim 5 further comprising communicating between the mobile device and the at least one elevator system with a transmitter and receiver.

10. The method of claim 5 further comprising communicating between the mobile device and the at least one elevator system with wireless communication.

11. The method of claim 5 further comprising:
transmitting a travel signal from the mobile device to the at least one elevator system; and
executing a hall call and car call for the at least one elevator system based on the travel signal.
